(19) United States
(12) Patent Application Publication
(10) Pub. No.: US 2026/0010093 A1
(43) Pub. Date: Jan. 8, 2026

(54) PRINTING SYSTEM OUTPUTTING A SHEET ON WHICH CHARGE REMOVAL PROCESSING IS PERFORMED AND CONTROL METHOD THEREFOR

(71) Applicant: CANON KABUSHIKI KAISHA, Tokyo (JP)

(72) Inventor: YOSHIAKI TANI, Ibaraki (JP)

(21) Appl. No.: 19/254,629

(22) Filed: Jun. 30, 2025

(30) Foreign Application Priority Data
Jul. 5, 2024 (JP) 2024-108791

(51) Int. Cl. G03G 15/02; G03G 15/00

(52) U.S. Cl. CPC G03G 15/0291; G03G 15/502

(57) ABSTRACT

A printing system includes a processor that, by execution of a program, operates as an output control unit for outputting a sheet on which a charge removal processing is performed at a first charge removal bias value, a display control unit for displaying a screen indicating the first charge removal bias value and receiving an operation, and a storage control unit for storing the first charge removal bias value as a sheet parameter in response to receiving an operation indicating that the first charge removal bias value is approved, wherein a sheet on which the charge removal processing is performed at a second charge removal bias value different from the first charge removal bias value is output in response to receiving an operation indicating that the first charge removal bias value is not approved.

### BACKGROUND

### Technical Field

The present disclosure relates to a printing system and a control method for the printing system.

### Description of the Related Art

A recording medium (hereinafter referred to as a sheet, as an example) used for printing is conveyed in an electrostatically charged state due to electrostatic charge remaining in an electrophotographic process or static electricity generated due to a small amount of friction between the sheet and a conveyance roller or a guide occurring during a sheet conveyance. Sheets may sometimes stick together due to the static electricity. In addition, the quality of the printed work may deteriorate as a result of dust or paper fine particles sticking to the sheet.

Because the electric resistance of plain paper or the like is low, and the electric charge easily moves in the paper, the charge amount itself is small and quick to be released. However, because the layer of toner on the sheet acts as a resistor, the sheet is charged more as the amount of the used toner is larger even if the sheet type is the same, and more static electric charge tends to remain on the sheet. For this reason, as a result, as the amount of toner on the sheet increases, the sheet is more likely to be charged, and more electric charge tends to remain. Further, in a case of two-sided printing, because the toner layer is formed on the front and back sides of the sheet, the charge transfer in the sheet is less likely to occur.

If post-processing is performed in a state where sheets are stuck together, there is a possibility that sheet alignment processing may be affected such that the quality of the post-processing deteriorates, and in addition, a sheet feed failure and a sheet jam may occur due to the conveyance failure at the post-processing time.

Thus, it is desirable to remove the static electricity remaining on a sheet after print processing, but before post-processing is performed, so as not to cause such a problem. To solve the above-described issue, Japanese Patent Application Laid-open No. 11-258881 discusses a method of removing the charge on the sheet by applying a voltage to a conveyance roller pair located downstream in the sheet conveyance direction. The charge removal method by the configuration of applying a voltage to the conveyance roller pair is a method of cancelling the charged static electricity by applying charge with a polarity opposite to that of the charge on the sheet, to the sheet via a charge removal roller. Thus, the charge removal control by the charge removal roller (application of a charge to the charge removal roller with a polarity opposite to that of the charge on the sheet) needs to be performed depending on the charge amount on the sheet. More specifically, there is an optimum charge adjustment value for removing charge (hereinafter referred to as a charge removal bias value) for each print environment, such as humidity, and brand of sheet. In a case where the charge removal control is performed on the sheet in a state where an electric charge amount is inappropriately set, the electrostatic charge may be caused to further cause the sheets to stick together.

When the charge removal bias value described above is set, a plurality of sheets can be printed, and the sticking state of the printed sheets can be checked. The charge removal bias value can be set and adjusted by changing the charge removal bias voltage depending on the sheet sticking state and again checking the sticking state of a subsequent print result. For this reason, when performing adjustments to obtain the optimum charge removal bias value, it is necessary to check the sticking states of the sheets output at a plurality of charge removal bias values. However, when the sheets printed out at different charge removal bias values are continuously output, the charges of the sheet transfer between the sheets, and the sheet sticking state cannot be correctly checked.

### SUMMARY

According to an aspect of the present disclosure, a printing system including a printing unit configured to print an image on a sheet and a charge removal unit configured to perform charge removal processing on the sheet printed by the printing unit includes at least one memory storing a program, and at least one processor that, by execution of the stored program, is configured to operate as: an output control unit configured to output the sheet on which the charge removal processing is performed at a first charge removal bias value, a display control unit configured to display on a display unit a check screen indicating the first charge removal bias value and receive an operation input by a user, and a storage control unit configured to store in a storage unit the first charge removal bias value as a parameter of the sheet in response to receiving an operation input by the user indicating that the first charge removal bias value is approved, wherein the output control unit performs control to output a sheet on which the charge removal processing is performed at a second charge removal bias value different from the first charge removal bias value in response to receiving an operation input by the user indicating that the first charge removal bias value is not approved.

Further features of the present disclosure will become apparent from the following description of exemplary embodiments with reference to the attached drawings.

### BRIEF DESCRIPTION OF THE DRAWINGS

FIG. 1 is a diagram illustrating a system configuration according to an exemplary embodiment.

FIG. 2 is a block diagram illustrating a system configuration of a printing apparatus according to the exemplary embodiment.

FIG. 3 is a diagram illustrating a cross-sectional view of a printing system according to the exemplary embodiment.

FIG. 4 is a diagram illustrating an operation unit provided on the printing apparatus according to the exemplary embodiment.

FIG. 5 is a block diagram illustrating a system configuration of a charge removal apparatus according to the exemplary embodiment.

FIG. 6 is a diagram illustrating examples of a sheet database reference screen and a change screen according to the exemplary embodiment.

FIG. 7 is a schematic diagram illustrating charge removal processing according to the exemplary embodiment.

FIG. 8 is a flowchart illustrating charge removal bias adjustment processing according to the exemplary embodiment.

FIG. 9 is a diagram illustrating examples of charge removal bias adjustment screens according to the exemplary embodiment.

FIG. 10 is a flowchart illustrating charge removal bias adjustment processing according to another exemplary embodiment.

FIG. 11 is a diagram illustrating an example of a charge removal bias adjustment screen according to the other exemplary embodiment.

### DESCRIPTION OF THE EMBODIMENTS

Exemplary embodiments of the present disclosure will be described in detail with reference to the attached drawings. Note that components described in the exemplary embodiments are merely examples and not intended to limit the range of the present disclosure only to the exemplary embodiments.

### Entire System Configuration

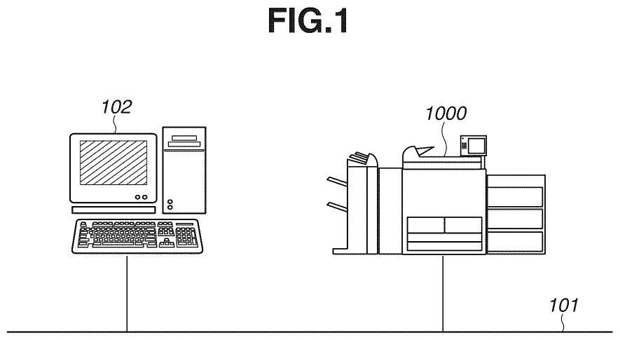

FIG. 1 illustrates a system configuration according to a first exemplary embodiment, including a printing system 1000 and a client computer (hereinafter referred to as a personal computer (PC)) 102, which are connected with each other via a network 101. The PC 102 can transmit page description language (PDL) code data serving as a print job to the printing system 1000 via the network 101. In FIG. 1, the network 101 is a wired network, but may be a wireless network.

### Hardware Configuration of Printing System

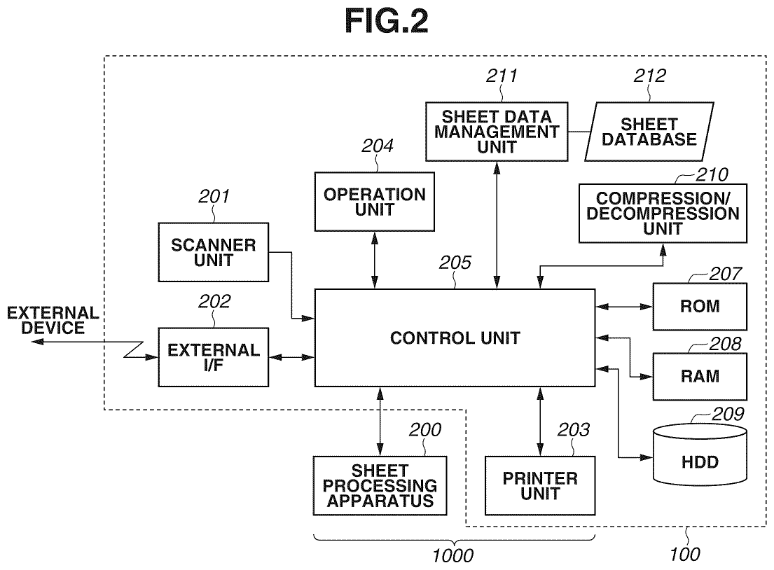

With reference to a system block diagram in FIG. 2, a hardware configuration of the printing system 1000 will be described. The printing system 1000 includes a printing apparatus 100, which is a portion surrounded by dotted lines in FIG. 2, and a sheet processing apparatus 200. An arbitrary number of the sheet processing apparatuses 200 can be connected to the printing apparatus 100. In the present exemplary embodiment, a multifunction peripheral (MFP) having a plurality of functions, such as a copy function and a printer function, is an example of the printing apparatus 100. However, the printing apparatus 100 may be a single function type printing apparatus having only a copy function or a printer function. In the present exemplary embodiment, as an example, assume that the printing system 1000 includes various components described below.

The printing system 1000 is configured in such a way that sheet processing is executed on the sheets printed by the printing apparatus 100, by the sheet processing apparatus 200 connected to the printing apparatus 100. However, the printing system 1000 can also be configured to include only the printing apparatus 100 without the sheet processing apparatus 200 being connected to the printing system 1000. The sheet processing apparatus 200 is configured to be communicable with the printing apparatus 100 and can receive an instruction from the printing apparatus 100 to execute the sheet processing described below.

A scanner unit 201 reads an image on a document, converts the read image into image data, and transmits the converted image data to another unit.

An external interface (I/F) 202 transmits and receives data to and from other devices connected to the network 101.

A printer unit 203 prints on a sheet an image based on input image data.

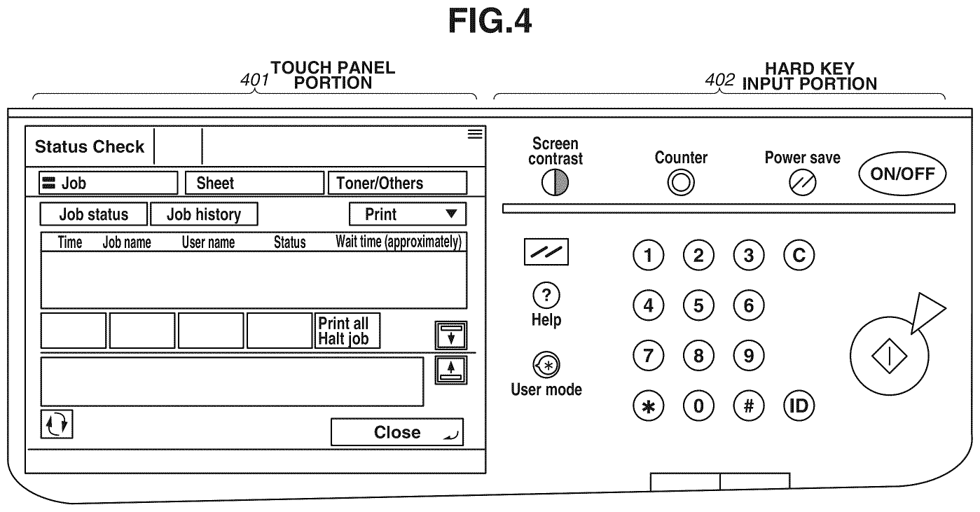

An operation unit 204 has a configuration as illustrated in FIG. 4 and includes a hard key input portion (key input portion) 402 and a touch panel portion 401 to receive instructions from a user therethrough. The operation unit 204 performs various displays on the touch panel portion 401 included in the operation unit 204.

A control unit 205 performs overall processing and operations control of the various units included in the printing system 1000. More specifically, the control unit 205 controls the operations of the printing apparatus 100 and the sheet processing apparatus 200 connected to the printing apparatus 100.

A read only memory (ROM) 207 stores various kinds of computer programs to be executed by the control unit 205.

For example, the ROM 207 stores programs for causing the control unit 205 to execute various kinds of processing, as illustrated in the flowcharts described below, or a display control program required for displaying various setting screens described below. The ROM 207 also stores a program for rasterizing the PDL code data received from the PC 102 and interpreted by the control unit 205 into raster image data. Further, the ROM 207 stores a boot sequence, font information, and the like.

A random access memory (RAM) 208 stores image data and the PDL code data transmitted from the scanner unit 201 or the external I/F 202, various kinds of programs and setting information loaded from the ROM 207. The RAM 208 stores information about the sheet processing apparatus 200 (e.g., information about a type and functions of the sheet processing apparatus 200 connected to the printing apparatus 100). The control unit 205 can use the information about the sheet processing apparatus 200 stored in the RAM 208 for the control.

A hard disk drive (HDD) 209 includes a hard disk, a drive unit for reading and writing data from and to the hard disk, and the like. The HDD 209 is a large-capacity storage device for storing image data input from the scanner unit 201 and compressed by a compression/decompression unit 210.

The control unit 205 can print the image data stored in the HDD 209 using the printer unit 203 based on an instruction from a user. The HDD 209 is used also as a spooler, and the control unit 205 can manage the PDL code data received from the PC 102 as a print job and store it in the HDD 209. The control unit 205 can manage print jobs stored in the HDD 209 and acquire the number of the stored print jobs and the setting information set to the print jobs.

The compression/decompression unit 210 compresses and decompresses the image data or the like stored in the RAM 208 or the HDD 209, using various kinds of compression methods such as Joint Bi-level Image experts Group (JBIG) and Joint Photographic Experts Group (JPEG) methods.

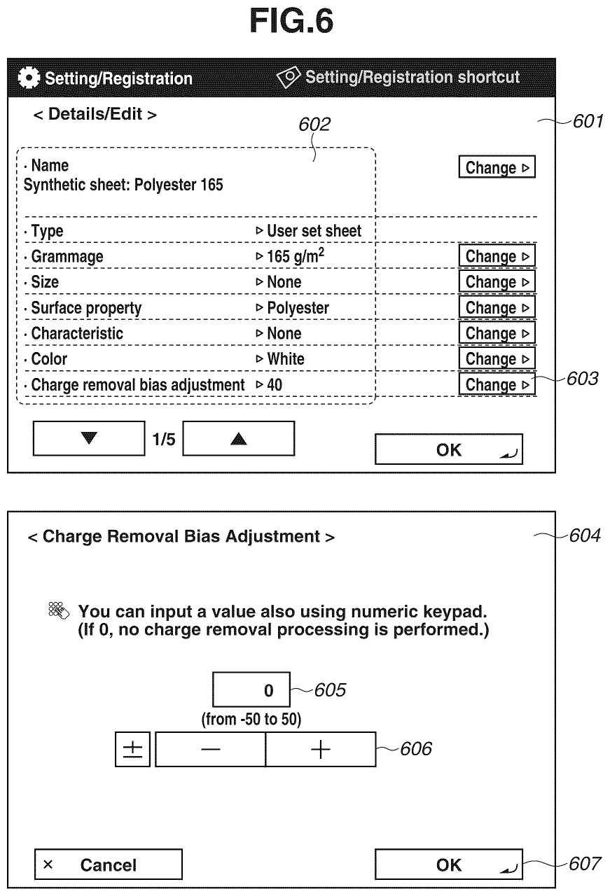

A sheet data management unit 211 manages, for each sheet type and each brand, parameters for expressing the sheet itself, such as a grammage, a surface property, a characteristic, and a fiber orientation of the sheet, and control parameters used when the sheet is printed, such as a voltage adjustment value at a transfer time and an applied voltage value at a charge removal control time. The sheet data itself, managed by the sheet data management unit 211, is illustrated as a sheet database 212 in the block diagram, but the sheet database itself is stored in the HDD 209 in such a form that the control unit 205 can refer to and set the sheet database 212 via the sheet data management unit 211. The sheet data management unit 211 has a function of providing a setting screen for referring to and editing the contents of the sheet database 212, and FIG. 6 illustrates screen examples. The printing system 1000 is configured so that a user is able to call a change screen for each sheet via the operation unit 204. Upon receiving the call, the control unit 205 displays a management screen 601 for referring to and changing the sheet parameters on the touch panel portion 401 of the operation unit 204.

### <Sheet Management Screen>

The management screen 601 includes a field 602 for displaying each parameter and a corresponding current setting value, and each parameter is provided with a change button to be pressed when the setting value is to be changed. For example, in a case where a “Change” button 603 is pressed by a user to change the charge removal bias adjustment parameter, which is an applied voltage value at a charge removal time, the control unit 205 displays a charge removal bias change screen 604 on the touch panel portion 401 of the operation unit 204. The charge removal bias change screen 604 includes a field 605 for displaying the current setting value, and an input button 606 ([+] and [−]) for inputting an increment or a decrement of the setting value. By operating the input button 606, the applied voltage value for the charge removal processing performed by a charge removal apparatus 200-3a described below can be set for the sheet. In the present exemplary embodiment, the bias voltage to be set at this time is set by a strength level in a range from 0 to 50, not a direct voltage value [kV]. For example, as an actual operation, the voltage applied to the charge removal roller is incremented or decremented by 0.1 [kV] for each 1 strength level. More specifically, the setting of the strength level 50 sets the applied voltage to +5 [kV]. The unit and the settable range of the setting value are merely examples, and they are not limited to the specific examples described herein.

### Hardware Configuration of Printing System

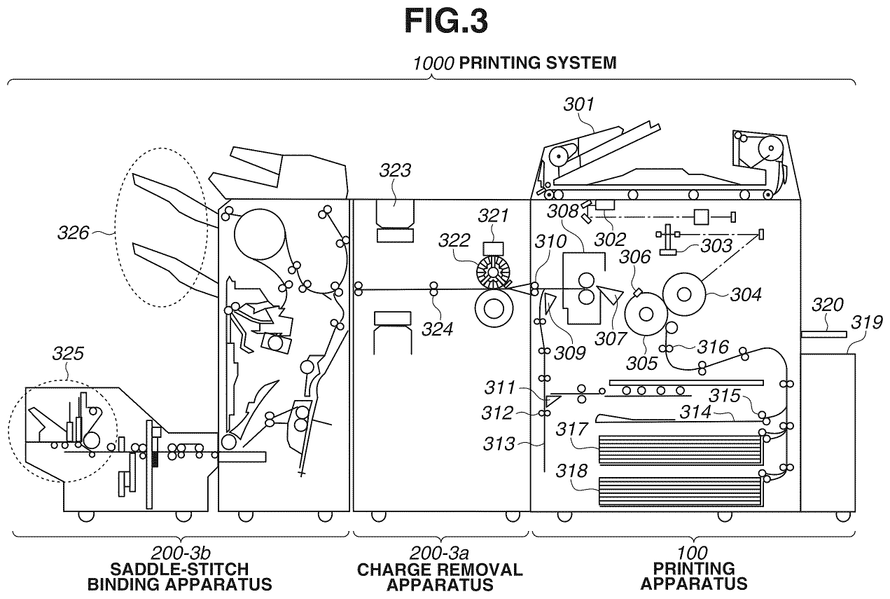

With reference to FIG. 3, a configuration of the printing system 1000 will be described. FIG. 3 is a diagram illustrating a cross-sectional view of the printing apparatus 100 and the sheet processing apparatus 200 connected to the printing apparatus 100. In FIG. 3, the sheet processing apparatus 200 includes the charge removal apparatus 200-3a and a saddle-stitch binding apparatus 200-3b.

### (Printing Apparatus)

The printing apparatus 100 will be described. An automatic document feeder (ADF) 301 sequentially separates a document bundle set on a stacking surface of a document tray from the first page in page order to convey the separated sheet onto an original platen glass for scanning the document by a scanner 302. The scanner 302 reads an image of the document conveyed onto the original platen glass and converts the read image into image data by a charge-coupled device (CCD) sensor. A rotatable polygonal mirror 303 receives a light beam, for example, a laser beam modulated based on the image data, and irradiates a photosensitive drum 304 with the laser beam as a reflection scan light beam via a reflection mirror.

A latent image formed on the photosensitive drum 304 by the laser beam is developed with toner, and the toner image is transferred onto a sheet medium adhering to a transfer drum 305.

A full-color image is formed by sequentially performing this series of image forming processes for yellow (Y), magenta (M), cyan (C), and black (K) toners. After these four image forming processes have been performed, the sheet medium with the full-color image formed thereon is separated from the transfer drum 305 by a separation pawl 306 and conveyed to a fixing device 308 by a pre-fixing carrier 307. The fixing device 308 includes a combination of a roller and a belt, includes a heat source such as a halogen heater therein, and melts and fixes the toner image transferred onto the sheet medium by applying heat and pressure. A sheet discharge flapper 309 is configured to be swingable with a swing axis as a center and regulates the conveyance direction of the sheet medium. When the sheet discharge flapper 309 swings in a clockwise direction in FIG. 3, the sheet medium is conveyed straight and discharged outside the printing apparatus 100 by a sheet discharge roller 310. The control unit 205 controls the printing apparatus 100 to perform one-sided printing through the sequence described above.

On the other hand, in a case where an image is formed on each side of the sheet medium, the sheet discharge flapper 309 swings in a counterclockwise direction in FIG. 3, and the conveyance direction of the sheet medium is changed downward to convey the sheet medium to a two-sided conveyance unit. The two-sided conveyance unit includes a reversing flapper 311, a reversing roller 312, a reversing guide 313, and a two-sided tray 314. The reversing flapper 311 swings with a swing axis as a center and regulates the conveyance direction of the sheet medium. In a case where a two-sided print job is processed, the control unit 205 controls the reversing flapper 311 to swing in the counterclockwise direction in FIG. 3 to convey the sheet with the printing completed on a first surface thereof by the printer unit 203 to the reversing guide 313 via the reversing roller 312.

The control unit 205 temporarily stops the reversing roller 312 in a state where the trailing edge of the sheet medium is nipped between the reversing roller 312 and its paired roller, and subsequently swings the reversing flapper 311 in the clockwise direction in FIG. 3. In addition, the control unit 205 rotates the reversing roller 312 in the opposite direction. In this way, the control unit 205 performs control so as to turn around and convey the sheet medium guiding it to the two-sided tray 314 in a state where the trailing edge and the leading edge of the sheet medium are switched. The sheet medium is temporarily stacked on the two-sided tray 314 and then conveyed to a registration roller 316 by a sheet re-feed roller 315. At this time, the sheet medium has been conveyed to the registration roller 316 in a state where the surface opposite the surface in the transfer process for the first sheet surface faces the photosensitive drum 304. In a manner similar to the process described above, a second image is formed on the second sheet surface. Images are formed on both surfaces of the sheet medium, and the sheet medium is discharged outside the main body of the printing apparatus 100 via the sheet discharge roller 310 after the fixing process. The control unit 205 controls the printing apparatus 100 to perform two-sided printing through the sequence described above.

The printing apparatus 100 includes a sheet feed portion for storing sheets required for the print processing. The sheet feed portion includes sheet feed cassettes 317 and 318 (e.g., 500 sheets storable in each cassette), a sheet feed deck 319 (e.g., 5,000 sheets storable), a manual sheet feed tray 320, and the like. Various types of sheets with different sizes or materials can be set separately in the sheet feed cassettes 317 and 318, and the sheet feed deck 319. Various kinds of sheets including special kinds of sheets, such as an overhead projector (OHP) sheet, can be set on the manual sheet feed tray 320.

### (Charge Removal Apparatus)

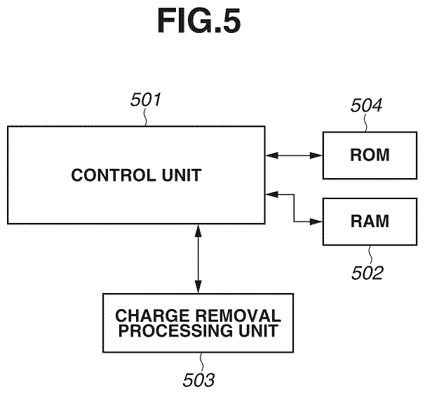

The charge removal apparatus 200-3a will be described. FIG. 5 is a block diagram illustrating a system configuration of the charge removal apparatus 200-3a. The charge removal apparatus 200-3a also includes a control unit 501 separate from the printing apparatus 100, and the control unit 501 is configured to perform an overall management of the entire charge removal apparatus 200-3a while communicating with the control unit 205 of the printing apparatus 100 in FIG. 2 via a bus (not illustrated).

A charge removal processing unit 503 performs charge removal processing on the conveyed sheet and includes a charge removal roller 322, an ionizer 323, and a voltage application controller 321 (described below) to supply a voltage to each of the charge removal roller 322 and the ionizer 323. The control unit 501 performs control to apply voltages to the charge removal roller 322 and the ionizer 323 via the voltage application controller 321.

A ROM 504 stores a boot program for the charge removal apparatus 200-3a, a charge removal processing program for the charge removal processing unit 503, and the like. The control unit 501 loads a required program as appropriate from the ROM 504 into a RAM 502 and executes it.

### [Charge Removal Processing]

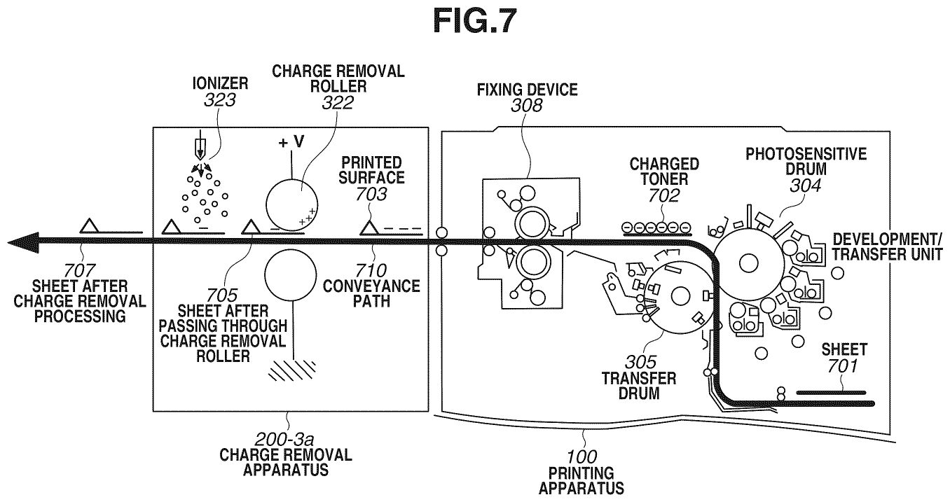

With reference to FIG. 7, charge removal processing performed by the charge removal processing unit 503 will be described. FIG. 7 is a diagram schematically illustrating a state where the charge removal processing is performed by the charge removal apparatus 200-3a on a sheet with the print processing performed thereon by the printing apparatus 100. Components common to those in FIG. 3 are assigned the same numbers.

A sheet 701 is conveyed to a development/transfer unit including the photosensitive drum 304 and the transfer drum 305 through a conveyance path 710, and toner is attached onto the sheet 701. Charged toner 702 attached to the sheet 701 is negatively charged, and the sheet 701 fixed by the fixing device 308 is conveyed to the charge removal apparatus 200-3a with a printed surface 703 of the sheet 701 charged negatively. The charge removal apparatus 200-3a includes the positively charged charge removal roller 322 that applies, by contact charge removal, positive charge (applied voltage value) to the negatively charged printed surface 703 to release the charged state. The charge removal roller 322 performs the charge removal processing using the applied voltage value set by the control unit 501, and the control unit 501 can change an applied voltage value during the charge removal processing. By changing the voltage applied to the sheet 701 during the charge removal processing, it is possible to change the charge removal effect for each area in one sheet.

However, enough of the negative charge may not have been removed as a result of the charge removal processing by the charge removal roller 322 or oppositely charged positive charge may remain on a sheet 705 that has passed under the charge removal roller 322. Thus, the charge removal apparatus 200-3a described in the present exemplary embodiment is further provided with the ionizer 323 on the downstream side of the charge removal roller 322. The ionizer 323 is a device that applies a voltage to an electrode needle provided therein to generate corona discharge, which removes the charge on the sheet 705 using the ions generated by the corona discharge. As described above, a sheet 707 discharged from the charge removal apparatus 200-3a after the charge removal processing is in a state where the charge is removed, by the charge removal roller 322 performing a rough charge removal, and further by the ionizer 323 removing the remaining charge.

Returning to the description with reference to the cross-section diagram in FIG. 3, the charge removal apparatus 200-3a includes the charge removal roller 322 and its paired roller to nip and convey the sheet that has been conveyed to the charge removal apparatus 200-3a, and the charge removal roller 322 described above performs the rough charge removal. Then, the ionizer 323 performs the charge removal processing of the remaining charge while the sheet is conveyed outside the charge removal apparatus 200-3a by a conveyance roller 324.

Now, the saddle-stitch binding apparatus 200-3b will be described. Examples of sheet processing performed by the saddle-stitch binding apparatus 200-3b include saddle-stitch binding, punching processing, cutting processing, shift sheet discharge processing, folding processing, stapling processing, and the like. In the present exemplary embodiment, these jobs are integrally referred to as a “saddle-stitch binding job”.

In a case where the saddle-stitch binding job is processed, the control unit 205 causes the charge removal apparatus 200-3a to convey the job sheet printed by the printing apparatus 100 to the saddle-stitch binding apparatus 200-3b, and then causes the saddle-stitch binding apparatus 200-3b to perform the sheet processing of this job. The control unit 205 causes the saddle-stitch binding apparatus 200-3b to hold the print product of the saddle-stitch binding job with the sheet processing performed by the saddle-stitch binding apparatus 200-3b on a sheet discharge tray 325 or 326 of the saddle-stitch binding apparatus 200-3b. Each of the sheet discharge trays 325 and 326 has a plurality of output destinations. The saddle-stitch binding apparatus 200-3b can perform a plurality of types of the sheet processing, and these output destinations are used for changing the output destination for each of the types of the sheet processing. The sheet discharge trays 325 and 326 each have a sensor for determining whether sheets remain on the sheet discharge trays 325 and 326. In the present exemplary embodiment, the detailed conveyance procedure of the saddle-stitch binding job will not be described.

### Processing in Printing System (Adjustment of Charge Removal Bias Value)

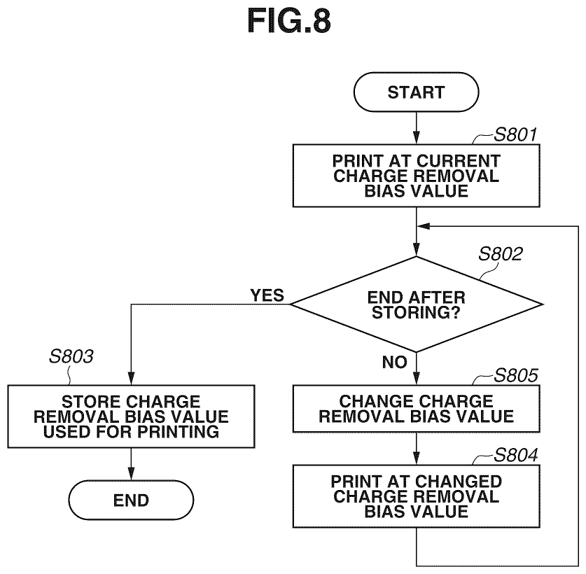

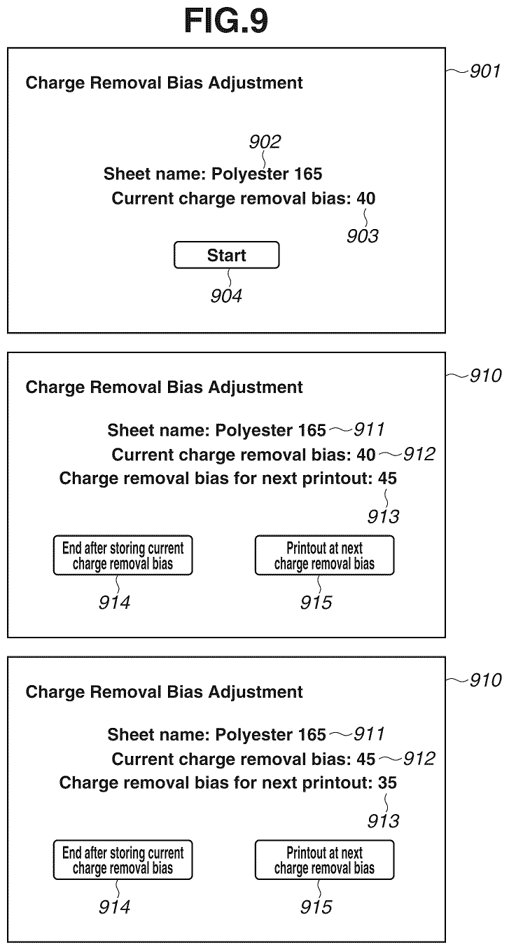

With reference to a flowchart in FIG. 8 and screen examples in FIG. 9, the operation of the printing system 1000 performed when the charge removal bias value is adjusted will be described. This processing is implemented by the CPU (computer) of the control unit 205 loading a program stored in the HDD 209 into the RAM 208 and executing the loaded program.

The charge removal bias value is adjusted to rewrite the charge removal bias value set in the sheet database 212 stored in the HDD 209. When the charge removal bias value is adjusted, the control unit 205 of the printing apparatus 100 displays an adjustment screen 901 for adjusting the charge removal bias value on the touch panel portion 401 of the operation unit 204.

### <Charge Removal Bias Value Adjustment Screen>

The adjustment screen 901 for adjusting the charge removal bias value displays a sheet name 902 of the adjustment target, a charge removal bias value 903 currently set for the adjustment target sheet, and a charge removal bias adjustment start button 904. In a case where a user presses the charge removal bias adjustment start button 904, the printing system 1000 starts the charge removal bias adjustment, and performs the operation illustrated in the flowchart in FIG. 8.

### [Charge Removal Bias Value Adjustment Processing]

When the charge removal bias adjustment processing starts, in step S801, the printing system 1000 prints out a job for the charge removal bias adjustment at the charge removal bias value set in the sheet database 212. At least two sheets are printed using the same charge removal bias value to check a sheet sticking state.

When the printing is completed, in step S802, the control unit 205 of the printing apparatus 100 changes the screen displayed on the touch panel portion 401 of the operation unit 204 to an adjustment result check screen 910 and waits for an operation from a user.

### <Charge Removal Bias Value Adjustment Screen>

The contents displayed on the adjustment result check screen 910 will be described. A sheet name 911 of the adjustment target displays the sheet name being used for the current charge removal bias adjustment. A current charge removal bias 912 displays the charge removal bias value used when the printing is performed for the adjustment at this time. A “Charge removal bias for next printout” 913 displays the charge removal bias value to be used in the printing performed when a “Printout at next charge removal bias” button 915 described below is pressed. An “End after storing the current charge removal bias” button 914 is a button for storing the current charge removal bias value and ending the adjustment.

In step S802, the control unit 205 determines whether an instruction to store the current charge removal bias value and end the adjustment is received from a user. In a case where the “End after storing the current charge removal bias” button 914 is selected by the user (YES in step S802), the processing proceeds to step S803. On the other hand, in a case where the “Printout at next charge removal bias” button 915, which is used when the user determines that the charge removal result is not appropriate based on the result output at the current charge removal bias, is selected (NO in step S802), the processing proceeds to step S805. The user checks whether the charge removal bias value is appropriate by checking the sticking state of the two or more sheets that are the print outputs of the job for the charge removal bias adjustment.

In step S803, the control unit 205 stores the charge removal bias value displayed in the current charge removal bias 912 in the sheet database 212 and ends the charge removal bias adjustment processing.

On the other hand, in step S805, the printing system 1000 changes the charge removal bias value to be used for the next printout to the value displayed in the “Charge removal bias for next printout” 913. The charge removal bias value to be used for the next printout is determined by a method of, for example, incrementing or decrementing the charge removal bias value from an initial value at a predetermined interval within a settable range.

In step S804, the control unit 205 starts the printing again using the changed charge removal bias value. Then, the processing returns to step S802. The user determines again whether the charge removal bias value is appropriate based on the output result. It is possible to adjust the charge removal bias value appropriately by repeating the determination until the determination result becomes “YES.” In the present exemplary embodiment, the control unit 205 starts the next printing after the “Printout at next charge removal bias” button 915 is pressed, but the control unit 205 may change the charge removal bias value and start the next printing in a case where the sensor detects that the sheets are removed from the sheet discharge tray.

In the first exemplary embodiment, the method of sequentially executing the print processing and adjusting the charge removal bias value by the user is performed.

In a case of the printing system like the printing system 1000, the printing system may have a plurality of sheet discharge trays as output destinations and sensors for determining whether sheets remain in the sheet discharge trays. When the charge removal bias value is adjusted in such a case, the user's operation time for removing the sheets can be reduced by continuously printing out the sheets to empty output destinations for the respective changed charge removal bias values. In a second exemplary embodiment described below, printing performed continuously to discharge print products to the empty destinations to reduce the user's operation time will be described.

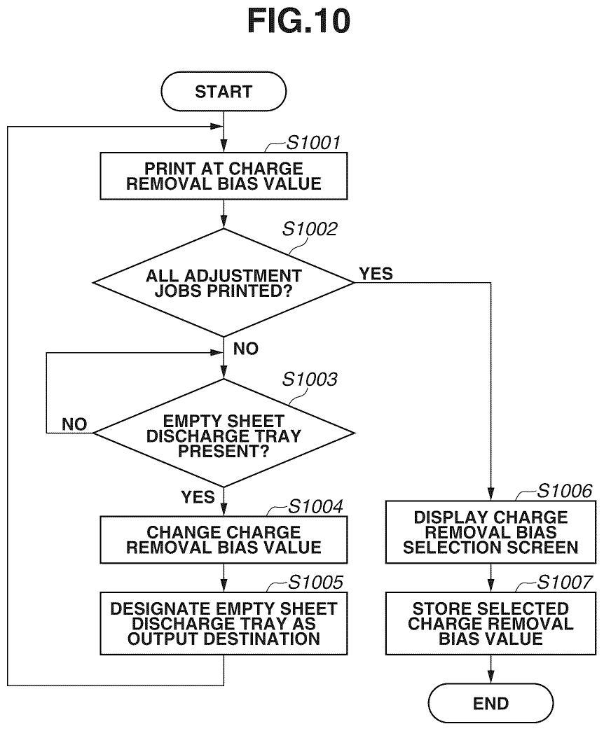

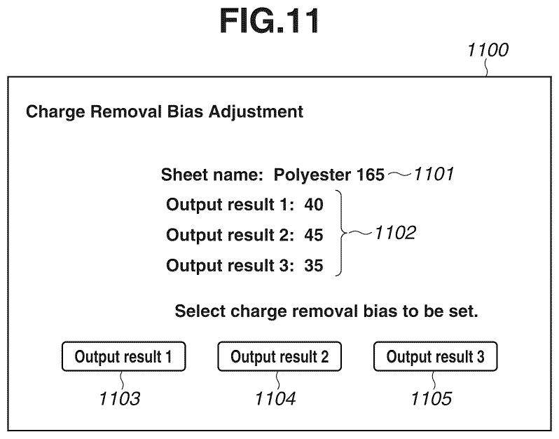

With reference to a flowchart in FIG. 10 and a screen example in FIG. 11, the second exemplary embodiment according to the present disclosure will be described. In the present exemplary embodiment, a charge removal bias adjustment flow will be specifically described.

### [Charge Removal Bias Value Adjustment Processing]

Descriptions up to starting the adjustment of the charge removal bias value are the same as those in the first exemplary embodiment, and thus, the descriptions thereof are omitted.

In step S1001, the printing system 1000 prepares a plurality of jobs for the charge removal bias adjustment (hereinafter referred to as adjustment jobs), and associates different charge removal bias values with the respective adjustment jobs. The printing system 1000 prints out the first job. Upon completing the printing of the first job, in step S1002, the printing system 1000 determines whether all the adjustment jobs have been printed out. In a case where the printing system 1000 determines that not all the adjustment jobs have been printed out (NO in step S1002), the processing proceeds to step S1003. In a case where the printing system 1000 determines that all the adjustment jobs have been printed out (YES in step S1002), the processing proceeds to step S1006.

In step S1003, the printing system 1000 determines whether an empty sheet discharge tray is present. Whether the discharge tray is empty can be detected by a sensor. In a case where the printing system 1000 determines that no empty sheet discharge tray is present (NO in step S1003), the printing system 1000 returns the processing to step S1003 and waits until the sheets on the sheet discharge tray are removed. In a case where the printing system 1000 determines that the empty sheet discharge tray is present (YES in step S1003), the processing proceeds to step S1004.

In step S1004, the printing system 1000 changes the charge removal bias value of the printing system 1000 to the charge removal bias value associated with the next adjustment job, to print out the next adjustment job.

Next, in step S1005, the printing system 1000 designates the sheet discharge tray determined to be empty in step S1003 as an output destination and returns the processing to step S1001 to print out the next adjustment job. The printing system 1000 repeats the printing of the adjustment jobs until the printing system 1000 determines that all the adjustment jobs have been printed in step S1002.

On the other hand, in the case where the printing system 1000 determines that all the adjustment jobs have been printed in step S1002, in step S1006, the control unit 205 of the printing apparatus 100 displays a charge removal bias selection screen 1100 on the touch panel portion 401 of the operation unit 204.

### <Charge Removal Bias Selection Screen>

With reference to FIG. 11, contents displayed on the charge removal bias selection screen 1100 will be described.

A sheet name 1101 of the adjustment target displays the sheet name used for the current charge removal bias adjustment.

In an output result display portion 1102, a charge removal bias value used for each of the adjustment jobs is displayed. Result selection buttons 1103, 1104, and 1105 respectively correspond to the output results in the output result display portion 1102, and a user who has checked the output results selects a button corresponding to the output result that the user thinks most appropriate. In the present exemplary embodiment, the print jobs at the three charge removal bias values are performed, but more adjustment jobs may be performed and displayed.

In step S1007, the printing system 1000 stores the charge removal bias value selected by the user in the sheet database 212 and ends the charge removal bias adjustment.

In this way, it is possible to perform the charge removal adjustment method to continuously execute charge removal adjustment jobs without waiting for the user's operation to remove the output result from the sheet discharge tray.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-108791, filed Jul. 5, 2024, the entirety of which is incorporated herein by reference.

What is claimed is:

1. A printing system including a printing unit configured to print an image on a sheet and a charge removal unit configured to perform charge removal processing on the sheet printed by the printing unit, the printing system comprising:
at least one memory storing a program; and
at least one processor that, by execution of the stored program, is configured to operate as:
an output control unit configured to output the sheet on which the charge removal processing is performed at a first charge removal bias value;
a display control unit configured to display on a display unit a check screen indicating the first charge removal bias value and receive an operation input by a user; and
a storage control unit configured to store in a storage unit the first charge removal bias value as a parameter of the sheet in response to receiving an operation input by the user indicating that the first charge removal bias value is approved,
wherein the output control unit performs control to output a sheet on which the charge removal processing is performed at a second charge removal bias value different from the first charge removal bias value in response to receiving an operation input by the user indicating that the first charge removal bias value is not approved.

2. The printing system according to claim 1, wherein the check screen further indicates the second charge removal bias value.

3. The printing system according to claim 1, wherein the check screen includes a first object for receiving the operation input by the user indicating that the first charge removal bias value is approved, and a second object for receiving the operation input by the user indicating that the first charge removal bias value is not approved.

4. The printing system according to claim 1,
wherein the second charge removal bias value differs from the first charge removal bias value by a predetermined amount, and
wherein the output control unit performs control to output a sheet on which the charge removal processing is performed at a third charge removal bias value different from the second charge removal bias value by the predetermined amount in response to a receiving an operation input by the user indicating that the second charge removal bias value is not approved.

5. The printing system according to claim 1, wherein the parameter of the sheet further includes a type and a grammage.

6. A printing system including a printing unit configured to print an image on a sheet, a charge removal unit configured to perform charge removal processing on the sheet printed by the printing unit, and a plurality of sheet discharge trays, the printing system comprising:
at least one memory storing a program; and
at least one processor that, by execution of the stored program, is configured to operate as:
an output control unit configured to output to each of the plurality of sheet discharge trays a sheet on which the charge removal processing is performed at a different one of a plurality of different charge removal bias values;
a display control unit configured to display on a display unit a screen for a user to input a selection of one of a plurality of output results; and
a storage control unit configured to store in a storage unit, as a parameter of the sheet, a charge removal bias value corresponding to the output result selected on the screen by the user.

7. The printing system according to claim 6, wherein the screen indicates a charge removal bias value corresponding to each of the plurality of output results.

8. The printing system according to claim 6, wherein the screen includes a plurality of objects each configured to receive from the user a selection of a charge removal bias value corresponding to one of the plurality of output results.

9. A control method for a printing system including a printing unit configured to print an image on a sheet and a charge removal unit configured to perform charge removal processing on the sheet printed by the printing unit, the control method comprising the steps of:
outputting the sheet on which the charge removal processing is performed at a predetermined charge removal bias value;
displaying on a display unit a check screen indicating the predetermined charge removal bias value;
receiving via the display unit an operation input by a user indicating whether the predetermined charge removal bias value is approved;
storing in a storage unit the predetermined charge removal bias value as a parameter of the sheet in response to receiving an operation input by the user indicating that the predetermined charge removal bias value is approved; and
performing control to output a sheet on which the charge removal processing is performed at a charge removal bias value different from the predetermined charge removal bias value in response to receiving an operation input by the user indicating that the predetermined charge removal bias value is not approved.
